(19) United States
(12) Patent Application Publication
(10) Pub. No.: US 2003/0131942 A1
(43) Pub. Date: Jul. 17, 2003

(54) Sticker stand structure for quick and accurate positioning and sticking on CD

(76) Inventor: Ting Shao Chieh, (US)

Correspondence Address: BRUCE H. TROXELL, SUITE1404, 5205 LEESBURG PIKE, FALLS CHURCH, VA, 22041, US

(21) Appl. No.: 10/047,062

(22) Filed: Jan. 17, 2002

(51) Int. Cl. B32B 1/00

(52) U.S. Cl. 156/391; 156/556

(57) ABSTRACT

The present invention is a <CD sticker stand structure> in the purpose of providing a structure able to put a sticker on a CD quickly and accurately; in particular an alternative positioning ring that can be used for square type or larger opening stickers.

### DESCRIPTION

At present CD flash is quite popular for the data storage. For the convenience of identification various methods are used such as ball pen marks or notes or more forma special stickers; when reading data CD rotates at high speed and the stability thereof affects directly the result of reading. In case of stickers used on CDs, attention must be paid to smoothness without bulgings or reveres. Also, CD stickers come in a various forms than inner opening. Stickers with larger or even square openings are produced when required making it more difficult for sticking on CDs.

Further, the present invention of <CD sticker stand structure> is composed of a pressing base, a contraction structure, a positioning rig a guiding column and a hand pressing button. The operational procedure begins with positioning of the sticker by the positioning ring onto the pressing platform, then a CD is inserted in between the pressing button and the guiding column and put into the positioning ring guided by the guiding, column; upon CD matched with the pressing base it is pressed down to go under the pressing platform and the operation is completed. The present invention of <CD sticker stand structure> has another feature of forming a larger positioning section at the other end of the positioning ring, which is in circular shape and has several partitions on it; the pressing platform provides matching positioning sections for larger stickers on projected positioning rings.

The present invention of <CD sticker stand structure> has an additional purpose of providing a square positioning set in place of the original positioning ring with a similar function for the square positioning set to be guided into the position just like the positioning ring; a pair of parallel positioning plates at both sides of the punch is formed and positioning punches prepared on top of the pressing platform to match with; therefore when a sticker has a square opening the operator may put the square positioning set under the pressing platform in a projected way for the purpose of positioning a square sticker.

One other function of the present invention of <CD sticker stand structure> is that a detachable under plate with screw opening is placed under the sticker structure for quick connection of the sticker stand and under plate by twist action.

### INSTRUCTION OF THE DIAGRAMS

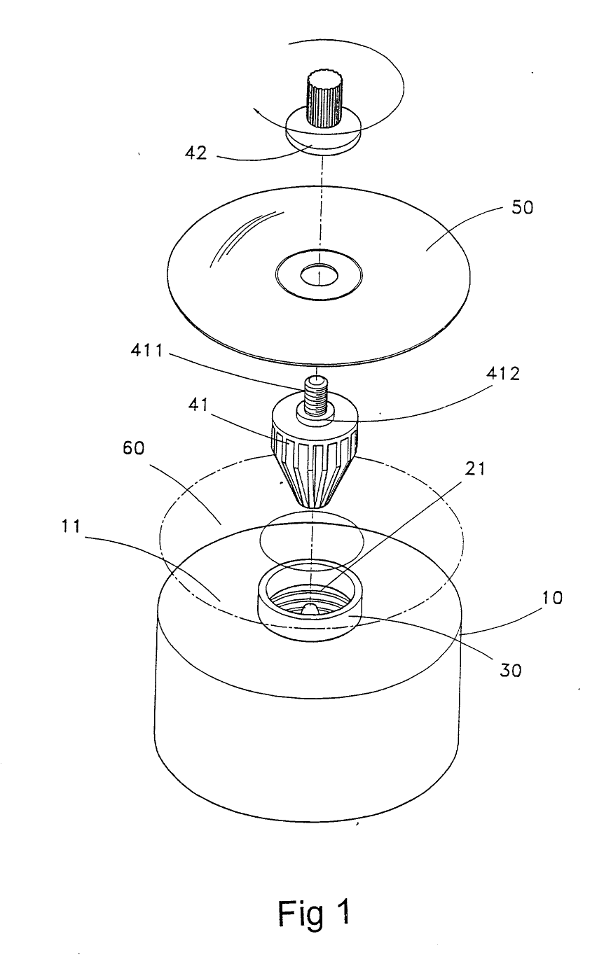

FIG. 1 is the perspective view of the present invention

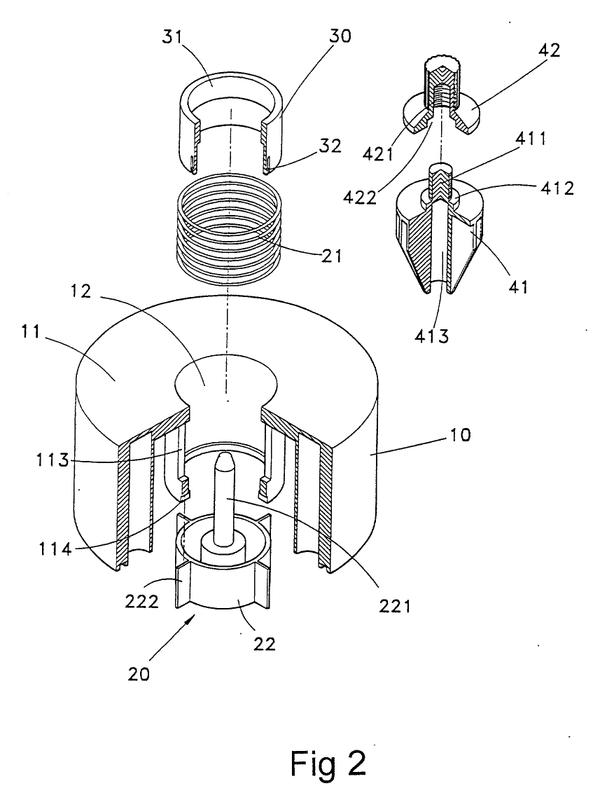

FIG. 2 is the structure analysis drawing

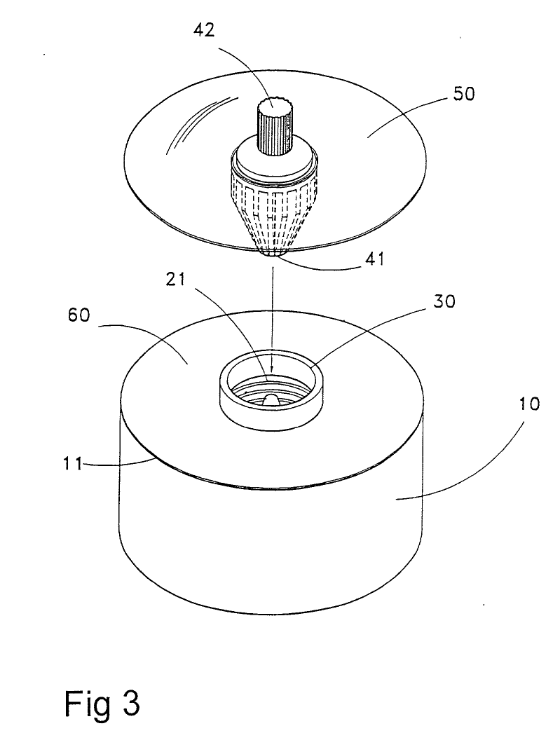

FIG. 3 is the embodiment reference drawing

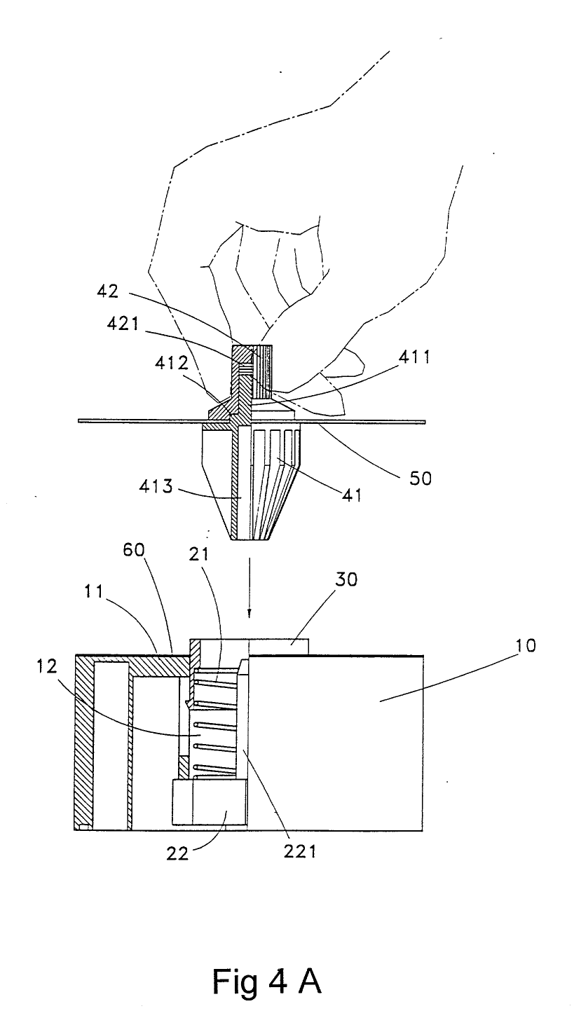

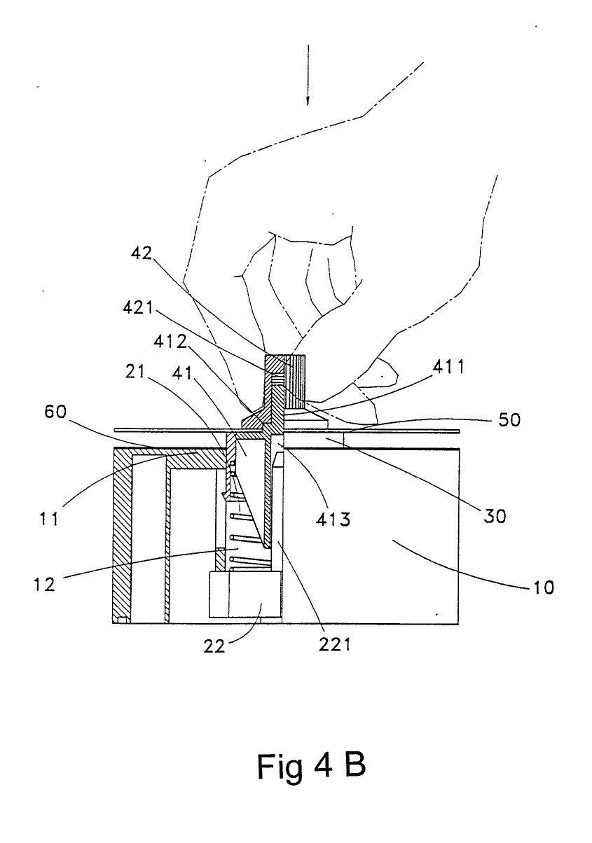

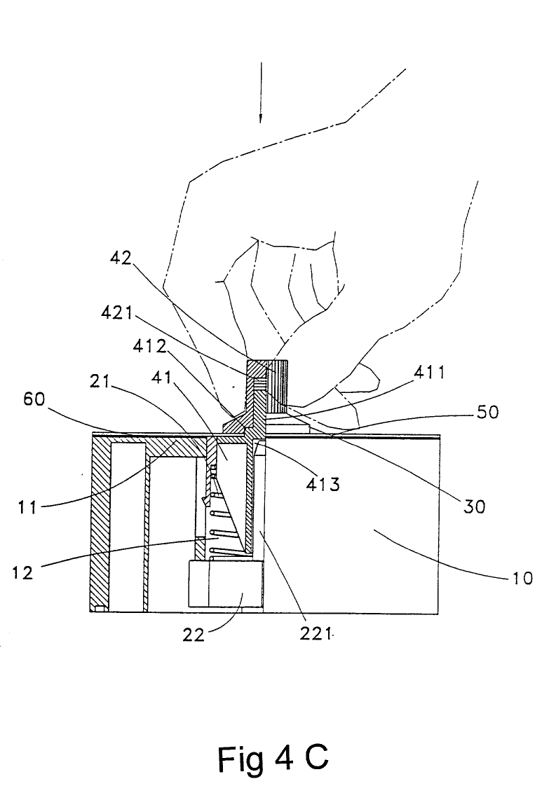

FIGS. 4(a),(b),(c) are the sectional drawings in operation

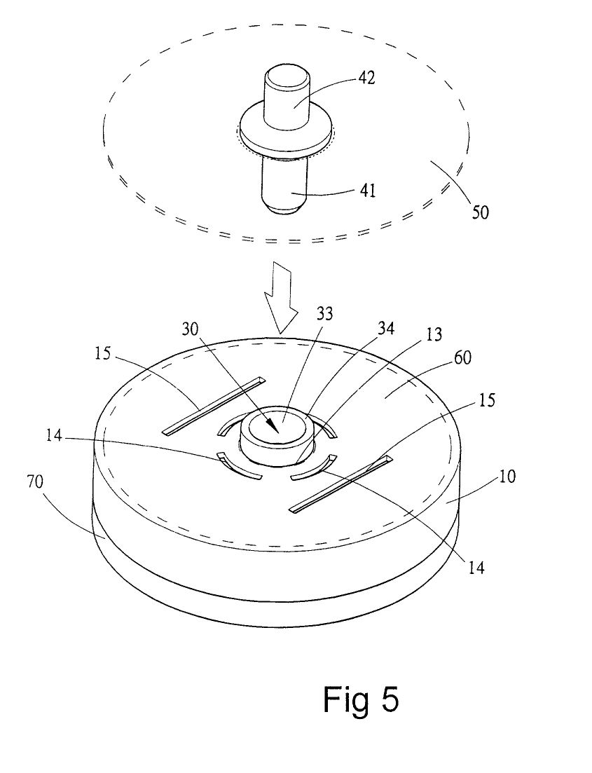

FIG. 5 is another example of embodiment

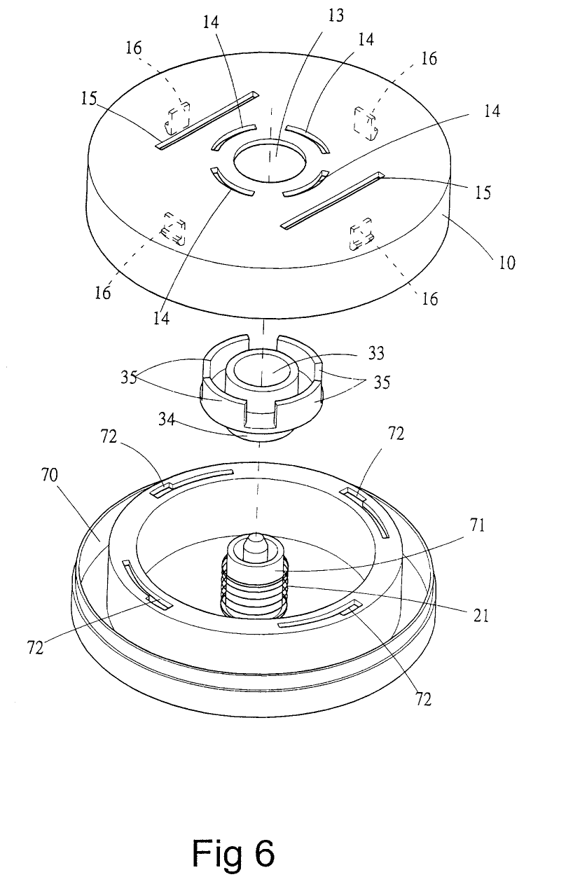

FIG. 6 is the structure analysis in another embodiment

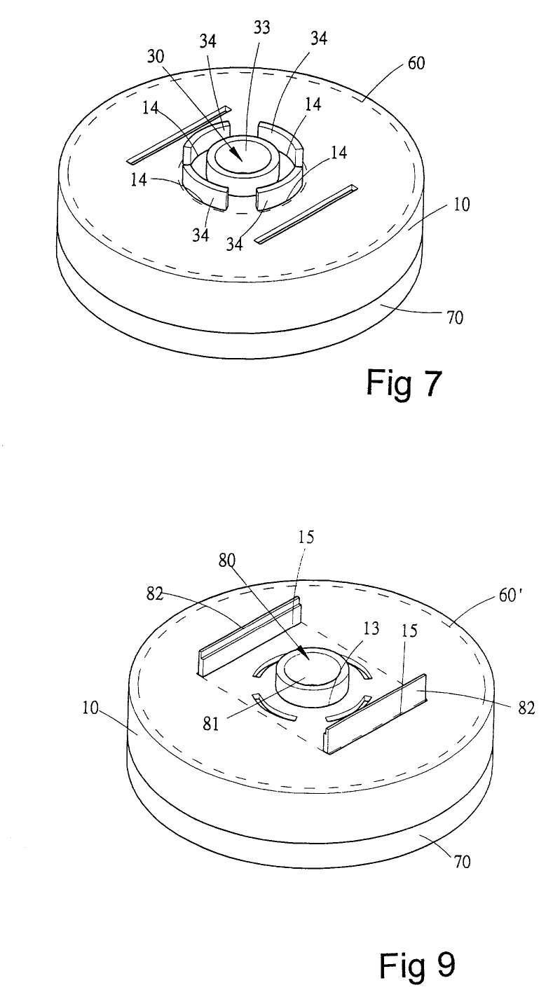

FIG. 7 is the operational drawing of larger square opening

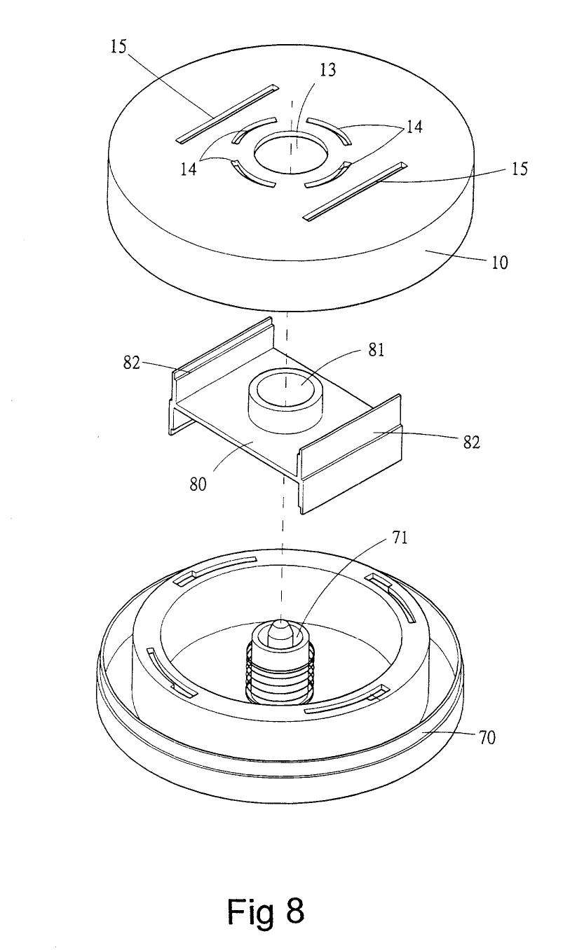

FIG. 8 is the assembly drawing of square opening sticker in positioning

FIG. 9 is another operational drawing of square opening sticker

(10) sticker press stand

(11) platform

(12) guiding base

(12 1) strait groove

(12 2) plug groove

(13) hole

(13) hole in the positioning section

(15) hole in the positioning plate

(16) clamp

(20) retrieve structure

(21) spring

(22 1) positioning bolt

(23) plug chip

(30) positioning ring

(31) inner convex edge

(32) hook

(33) hole

(34) positioning ring

(35) ring shape positioning section

(41) guiding column

(41 1) the first lock section

(41 2) positioning block

(41 3) positioning hole

(42) screw button

(42 1) second lock section

(42 2) retaining section

(50) CD

(60) sticker

(60 1) sticker

(70) under plate

(71) guiding base

(72) twist hole

(80) square positioning casing

(82) positioning plate

The present invention of <CD sticker stand structure> includes the main structure of the device as shown in FIG. 1 and FIG. 2 comprising: a platform (11) on the top of a pressing base (10), a guiding base (12) extending downwards from the platform (11), a retrieving mechanism (20) set up in the guiding base (12) consisted of a spring (21) and a bottom plug (22) on a positioning bolt (22 1); a positioning ring (30) combined with the retrieving mechanism (20) for sticker positioning; the pressing base (10) and guiding base (12) engraved in their inner walls with straight grooves (12 1), plug groove (12 2) set at the bottom edge; a plug plate (22 2) formed by combination of the bottom plug (22) and the plug groove for placement under the guiding base (12), the spring is set inside the guiding base (12) and the positioning ring set on top of the spring; further the positioning ring (30) has inner edge and the bottom has clamping hook for their connection when the former is placed inside to clamp in the straight groove of the guiding base; the positioning ring pushed by the spring to extend outside the platform at proper section for sticker positioning.

In addition the cramping device is composed of a guiding column and a screw button as shown in FIG. 1 and FIG. 2 in which, the guiding column is a structure to go with the positioning ring forming the first lock section; a positioning part is constructed at the junction of the first lock section and the guiding column; the guiding column has a tapping end from the middle downwards and the center is to form a positioning hole with the above mentioned bottom plug; the twist press button is for turning and locking on top of the guiding column with the aim to press down the CD; the press button provides on the top a holding part and a second lock down the bottom connecting by mutual turns of the first and second lock parts to press the CD solid in between.

The way of mechanism of the present invention is shown in FIGS. 4(a), (b), (c). First a sticker is put on the platform and a CD pressed in between the press button and the guiding column and then guided by the guiding column into the positioning ring matching the CD and the sticker correctly; with the CD pressed down the guiding column enters the positioning hole without deviation and sinking down together with the positioning ring to below the platform; the process is completed. As shown in FIG. 5 and FIG. 6, the press button is to connect with the bottom plate by screwing and inside the press button there is a guiding base and a spring; a positioning ring is installed which cases the outer part of the guiding base through the center; pushed by the spring, the positioning ring extends to a certain section of the platform for the sticker opening pressing the sticker tightly on the platform; another guiding column together with a screw button holds the CD for its entering into the center hole of the guiding base; when CD matched precisely with the press stand and pressed down, the positioning ring sinks below the platform base and the process is completed.

In particular, a larger ring shape positioning section is formed at the other end of the positioning part; the ring shape positioning section being in circular structure and having several partitions; the press stand forms a opening for outgoing ring shape section at the positioning part; therefore in case of a sticker with larger opening the operator may use the ring shape positioning section putting it under the press stand and extending outwards for positioning of a sticker with larger opening.

As shown in FIG. 8 and FIG. 9 whereas the positioning ring can be substituted by a square positioning set (80); the main part of the square positioning set can enter the hole (81) of the guiding base (71) just as the positioning ring; a pair of parallel plates (82) to be attached by the sides of hole (81); a positioning hole (15) is made outside the hole (13) for the outgoing of the positioning plate (82); in case of a sticker (60) with square opening, the operator may put the square shape positioning set (80) under the press stand (10) making the positioning plate (42 2) extend outside the press stand (10) for the positioning of a sticker (60) with square opening; in reference to FIG. 6, there is a detachable bottom plate (70) below the press stand (10) which has a screw hole (72) and clamp (16) for quick engagement of the press stand (10) and the bottom plate (70).

The present invention of <CD sticker stand structure> is a special sticker stand structure comprising a press stand, a retrieving device installed inside the press stand, a positioning ring, a guiding column and a hand screw button for quick and correct joint of CD sticker and further more, the positioning ring can be substituted by a square positioning set for placement of a larger sticker or a sticker with a square opening. This alternative structure is put forward for additional application of new type of invention

I claim:

1. A <CD sticker stand structure> comprising mainly: a press stand, a retrieving device installed inside the press stand, a positioning ring connected to the retrieving device, a guiding column and a hand screw button which features that the press stand has a platform on the top; a guiding column at the center extends downwards to form a guiding base; a retrieving device is installed inside; further a positioning ring connected with the guiding base and the retrieving device and pushed by a spring to extend outside to a proper section on the platform for the positioning of a sticker; the guiding column is to enter the positioning ring to form the first lock on its top; the screw button has a holder on the top and a second lock below; the guiding column and the screw button can be connected through the first lock and the second lock to hold a CD in between; the operator sticks a sticker on the positioning platform and then guides it by the guiding column into the positioning ring to match the CD with the press stand; by pressing down the CD is sunk to below the platform to complete the process.

2. A <CD sticker stand structure> of the claim 1, wherein said guiding column has a straight groove on the inside wall and a plug groove underneath; a retrieving device composed of a spring and a bottom plug which is placed at the guiding base; the spring installed inside is to set the positioning ring on its top; the positioning ring has a convex edge inside and a hook at the exterior bottom; when the positioning ring is set in the inner circle of the guiding base the spring is set simultaneously below the inner edge and then the positioning ring enters the straight groove guided by the hook.

3. A <CD sticker stand structure> of the claim 1, wherein a positioning section is formed through combination of the lock and the top surface of said guiding column.

4. A <CD sticker stand structure> of the claim 2, wherein said guiding column has a positioning hole at the center for the positioning bolt.

5. A <CD sticker stand structure> of the claim 1, wherein said press stand on the platform has a passage for the positioning ring; another larger positioning section is located at the other end in circular shape with several partitions; an exit is formed outside the top of the press stand for the outgoing ring shape positioning section; by that in case of a sticker with larger opening the operator shall put the ring shape positioning section upwards below the press stand; the ring shape positioning section extends out of the press stand for the positioning of sticker with larger opening.

6. A <CD sticker stand structure> of the claim 5, wherein said positioning ring can be substituted by a square positioning set which just as the positioning ring has a passage for entering the guiding base; a pair of parallel plates are installed at both sides of the passage which provides an outlet for the positioning plates; therefore in case of square opening sticker the operator may put the square positioning set below the press stand; the positioning plate extends out of the press stands for the positioning of square opening sticker.

7. A <CD sticker stand structure> of the claim 5 or 6, wherein said press stands has a detachable bottom plate with screw eye; the bottom plate together with the screw and clamp join the press stand and the bottom plate.
